(19) United States
(12) Patent Application Publication
(10) Pub. No.: US 2025/0210947 A1
(43) Pub. Date: Jun. 26, 2025

(54) Cable Post Guide

(71) Applicant: Digger Specialties, Inc., Bremen, IN (US)

(72) Inventor: Richard R. Pletcher, Nappanee, IN (US)

(21) Appl. No.: 18/989,907

(22) Filed: Dec. 20, 2024

Related U.S. Application Data
(60) Provisional application No. 63/613,993, filed on Dec. 22, 2023.

(51) Int. Cl. H02G 1/08; E04H 17/00

(52) U.S. Cl. CPC H02G 1/083; E04H 17/017

(57) ABSTRACT

A cable post guide is provided. The cable post guide is configured to assist feeding a cable through at least one cable hole disposed through a post. The cable post guide includes a base and a feed guide pin. The feed guide pin extends from the base. The feed guide pin is configured to extend through the at least one cable hole disposed through the post.

### RELATED APPLICATIONS

The present Application relates to and claims priority to U.S. Provisional Patent Application, Ser. No. 63/613,993, filed on Dec. 22, 2023, entitled “Cable Post Guide.” The subject matter disclosed in that Provisional Application is hereby expressly incorporated into the past Application.

### TECHNICAL FIELD AND SUMMARY

The present disclosure relates to railings, fences, and like barriers, and, particularly, to cables and cable guides for use with such railings, fences, and like barriers.

Cable barriers, particularly, horizontal rail cable barriers, are composed of a top rail extending between two or more posts. Under the top rail, one or more cable rails may extend between the two or more posts. Multiple cable rails may be located periodically along the height of the posts to form the barrier. Typically, the cable rails may be affixed to a first end post, extend through one or more intermediate posts, and then affixed to a second end post. Depending on the length of the barrier needed, the cable rails may extend through multiple intermediate posts before being affixed to the second end post. Each cable is then tensioned to provide a desired amount of rigidity.

An issue with horizontal rail cable barriers is that during installation, the cables need to be fed through the one or more of these intermediate posts. Typically, these posts include cable holes that extend all the way through, in the case of a solid post, or openings on opposing sides in the case of a hollow tubular post. With regards to the latter, feeding or drawing a flexible cable through a small hole on one side of the post and then aligning the cable with the opposing hole on the opposite side of the post can be time-consuming. This is especially the case if multiple cables need to be fed through multiple posts. The time it takes to do this adds up.

Accordingly, in an effort to mitigate the time consumption involved in feeding cables through posts, particularly, hollow tubular posts, the present disclosure provides a cable post guide to assist in feeding these posts.

An illustrative embodiment of the present disclosure provides cable post guide configured to assist feeding a cable through at least one cable hole disposed through a post. The cable post guide includes a base and a feed guide pin. The feed guide pin extends from the base. A first guide wall and a second guide wall extend from the base. The second guide wall is spaced apart from the first guide wall. The feed guide pin extends from the base between the first guide wall and the second guide wall. The feed guide pin is also configured to extend through the at least one cable hole disposed through the post. The feed guide pin further includes a cable receiver located at an end of the feed guide pin distal from the base. The cable receiver is also configured to receive an end portion of the cable.

In the above and other illustrative embodiments, the cable post guide may further comprise: the base having a width configured to be wider than a width of the post; a space located between the first guide wall and the second guide wall configured to receive the post; the feed guide pin having a length that is configured to extend from a first end of the post and through to a second end of the post; the cable receiver has a bore configured to receive the end portion of the cable; the feed guide pin is configured to be pushed into a cable opening in the post so that the end portion of the cable is extendable into the cable receiver so that when the feed guide pin is removed from the cable opening in the post, the cable is movable with the feed guide pin and extendable through the cable opening; a space is located between the first guide wall and the second guide wall configured to be sized so that when the first guide wall is positioned adjacent a first side surface of the post and the second guide wall is positioned adjacent a second side surface of the post, the cable post guide is aligned with a cable opening of the post; the feed guide pin is configured to be extendable through a first end of the post but not through a second end of the post; and a cross-sectional shape of the first guide wall, the base, and the second guide wall are configured to at least approximate at least a portion of a cross-sectional shape of the post and be positionable adjacent the portion of the cross-sectional shape of the post.

Another illustrative embodiment of the present disclosure provides a cable post guide configured to assist feeding a cable through at least one cable hole disposed through a post. The cable post guide includes a base and a feed guide pin. The feed guide pin extends from the base. The feed guide pin is configured to extend through the at least one cable hole disposed through the post.

In the above and other illustrative embodiments, the cable post guide may further comprise: a first guide wall that extends from the base; a second guide wall that extends from the base, wherein the second guide wall is spaced apart from the first guide wall; the feed guide pin extends from the base between the first guide wall and the second guide wall; the feed guide pin includes a cable receiver located at an end of the feed guide pin distal from the base; the cable receiver is configured to receive an end portion of the cable; the feed guide pin is configured to be pushed into the at least one cable hole in the post so that an end portion of the cable is extendable into a cable receiver so that when the feed guide pin is removed from the at least one cable hole in the post, the cable is movable with the feed guide pin and extendable through the at least one cable hole.

Another illustrative embodiment of the present disclosure provides a method of feeding a cable through a post having a first cable opening located on first end of the post and a second cable opening located on a second end of the post, the method comprising the steps of: providing a cable post guide that includes a base and a feed guide pin extending from the base, wherein the feed guide pin includes a cable receiver; extending the feed guide pin through the first cable opening of the first end of the post; engaging an end portion of the cable with the cable receiver adjacent the second end of the post; pulling the base of the cable post guide away from the first end of the post so that the cable is moving into the post while the feed guide pin is being removed from the post; continuing moving the base from the post so that the cable post guide exits the first cable opening of the first end of the post with the end portion of the cable also exiting the first cable opening of the first end of the post with the cable extending completely through the post; and removing the cable receiver from the end portion of the cable.

The method of feeding the cable through the post further comprising the steps of: extending the feed guide pin through the first cable opening of the first end of the post until the base of the cable post guide abuts the first end of the post, and pushing the end portion of the cable against the cable receiver while pulling the base of the cable post guide away from the first end of the post so that the cable is moving into the post while the feed guide pin is being removed from the post; providing the cable post guide with a first guide wall that extends from the base, a second guide wall that extends from the base, and the second guide wall being spaced apart from the first guide wall, moving the first guide wall and the second guide wall along corresponding side walls on the post when extending the feed guide pin through the first cable opening of the first end of the post until the base of the cable post guide abuts the first end of the post; and moving the feed guide pin through the first cable opening of the first end of the post so the cable receiver becomes located adjacent the second cable opening of the second end of the post when the base abuts the first end of the post, wherein the cable receiver of the feed guide pin does not extend through the second cable opening of the second end of the post.

Additional features and advantages of the cable post guide will become apparent to those skilled in the art upon consideration of the following detailed descriptions of carrying out this cable post guide as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a side view of a cable barrier;

FIG. 2 is a perspective detail progression view of a portion of a post with a cable and cable post guide;

FIG. 3 is another perspective detail progression view of a portion of the post with the cable and cable post guide with the cable guide inserted into the cable holes;

FIG. 4 is another detail progression view of a portion of the post with the cable and cable post guide with the table inserted into the cable post guide;

FIG. 5 is another detail view of a portion of a post with the cable and cable post guide with the cable post guide removed from the cable holes in the post and the cable extended through the cable holes;

FIG. 6 is another detail progression view of a portion of the post with the cable and cable post guide with the cable separated from the cable post guide;

FIG. 7 is a perspective view of the cable post guide;

FIG. 8 is another perspective view of the cable post guide;

FIG. 9 is a top cross-sectional view of a post, cable, and cable post guide with the cable post guide inserted into the cable hole and the cable inserted into the cable post guide;

FIG. 10 is another top cross-sectional view of a post, cable, and cable post guide with the cable being drawn through the post with the cable post guide;

FIG. 11 is another top cross-sectional view of a post, cable, and cable post guide with the cable drawn through the post;

FIG. 12 is a side cross-sectional view of the cable post guide; and

FIG. 13 is a top cross-sectional view of the cable post guide.

Corresponding reference characters indicate corresponding parts throughout the several views. The exemplification set out herein illustrates embodiments of the cable post guide and such exemplification is not to be construed as limiting the scope of the cable post guide in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well-known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a cable post guide to assist in feeding these posts. The cable post guide includes a feed guide pin which can be inserted into the cable hole on one side of the post and be positioned axially with and adjacent to the cable hole on the opposite side of the post. A cable end can be inserted into that opposite side cable hole and engage the end of the feed guide pin. Then, by concurrently pushing the cable against the feed guide pin while moving the cable post guide, and, particularly, the feed guide pin out of the post, the cable is fed through the entire post. The result is that feeding cables through intermediate posts becomes a relatively simple and less consuming process.

In certain embodiments, the feed guide pin may include a cable receiver at its end that is sized to either receive the end of the fed cable or serve as a locator. Regardless, whether the cable is fully received in the cable receiver or just at its end, the process of feeding the cable through the post is the same. On one side of the post, the cable is pushed against the feed guide pin of the cable post guide while at the same time it is pulled out of the post. The cable is aligned with both openings so the end of the cable can enter and exit the opposed cable holes. This provides a convenient method for feeding the cable therethrough.

In some embodiments, the cable post guide may include a base with the feed guide pin extending therefrom, with opposed guide walls spaced apart and extending generally parallel with the feed guide pin. The base may be about the width of the post so the guide walls generally abut opposing sides of the post. When the feed guide pin is inserted into the cable hole, the guide walls and base assist in aligning the feed guide pin so its end will align with the cable hole in the opposite wall. It is appreciated that the cable post guide can be made of a variety of widths to accommodate the variety of widths of various posts.

It is appreciated that in some embodiments, the cable post guide includes only the base and feed guide pin. The size and shape of the base may be such that, when placed flat against the wall of the post with the feed guide pin inserted into the cable hole, the feed guide pin will be aligned with the cable hole on the opposing wall of the post.

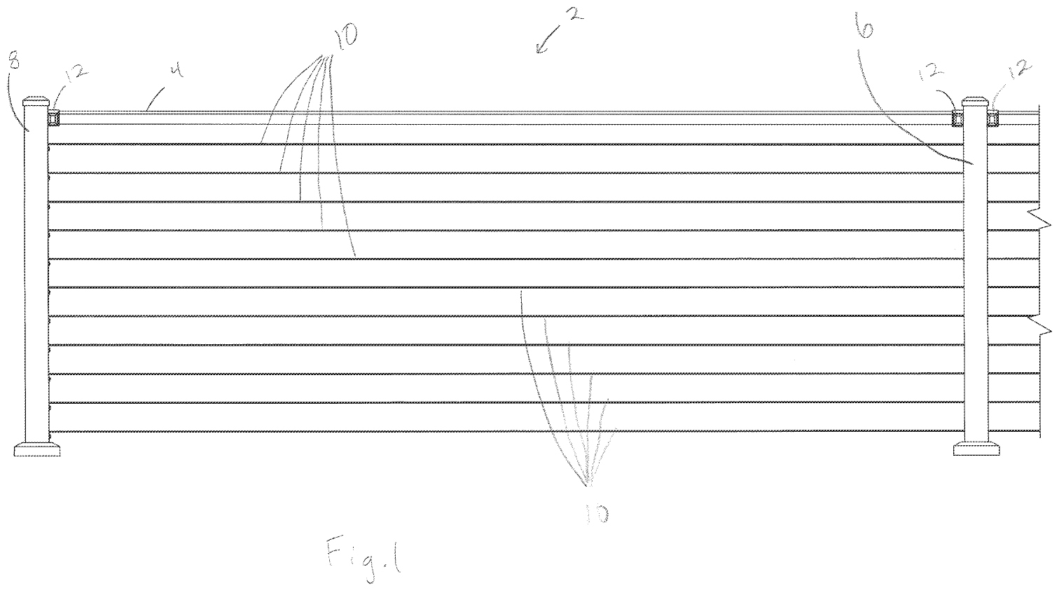

A side view of a cable barrier 2 is shown in FIG. 1. This illustrative embodiment of cable barrier 2 is illustratively composed of a top rail 4 extending between vertically oriented posts 6 and 8. A plurality of cables 10 are vertically spaced apart from each other and extend generally horizontally from post 8 through post 6. It is appreciated that cables 10 can extend as long as needed. It is appreciated in this view that post 6 is an intermediate pass-through post, while post 8 is an end post. Each of cables 10 extends through both sides of post 6. Depending on the desired length of cable barrier 2, multiple intermediate posts 6 may be positioned along the barrier line so as to support each of cables 10. Another end post (not shown), like post 8, is located on the other end of cable barrier 2 to define the distal end of cable barrier 2. It is further appreciated that top rail 4 may be secured to posts 6 and 8, via support brackets 12, as illustratively shown.

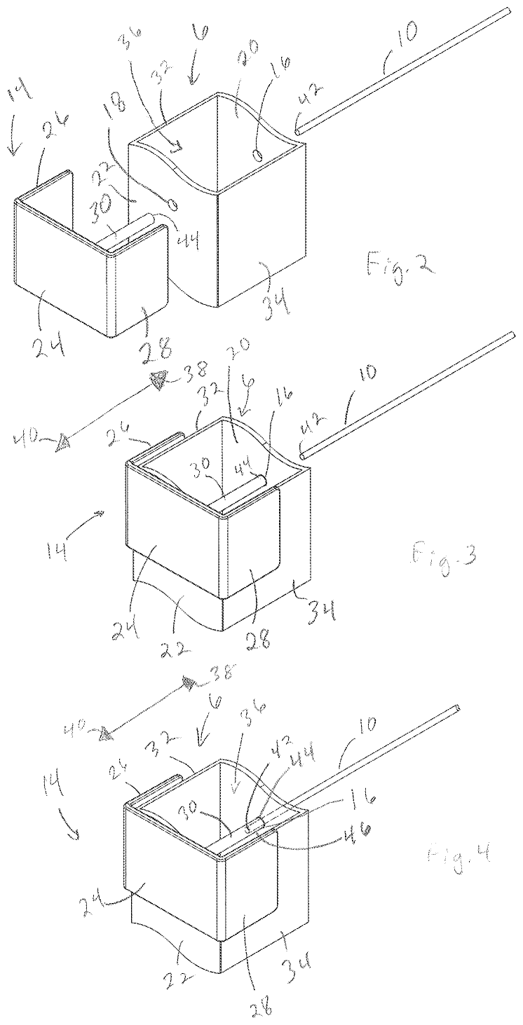

A detail exploded view of a portion of post 6, along with a cable post guide 14 and cable 10 is shown in FIG. 2. This view, along with FIGS. 3, 4, 5, and 6, are progression views demonstrating how cable post guide 14 assists in conveniently threading cable 10 through post 6. As shown in FIG. 2, both cable post guide 14 and cable 10 are exterior of post 6. Cable holes 16 and 18 are disposed opposite each other on walls 20 and 22, respectively, on post 6. It is intended that, in order to construct a cable railing of a type shown in FIG. 1, cables 10 need to be strung through post 6, and, particularly, through cable holes 16 and 18.

Cable post guide 14 may be composed of a base 24 that spans between transversely extending side or guide walls 26 and 28 as illustratively shown. A feed guide pin 30 extends from a central portion of base 24 and is located between guide walls 26 and 28. Feed guide pin 30 is sized both in its diameter and length to fit into cable hole 18 and extend adjacent cable hole 16. Illustratively, base 24 is generally the width of wall 22 so that guide walls 26 and 28 will be positioned adjacent sidewalls 32 and 34, respectively. (See, FIG. 3.) The purpose of cable post guide 14 is to provide a structure within cavity 36 of post 6 that cable 10 can engage and use to guide same through post 6 and out cable hole 18. As will be shown further herein, by moving both cable post guide 14 and cable 10 together in direction 40, which extends cable 10 further into post 6 and withdraws feed guide pin 30 from post 6, cable 10 will be led out of post 6 through cable hole 18 so long as there is constant or intermittent contact between end 42 of cable 10 and end 44 of cable post guide 14.

Another detail perspective view of post 6 is shown in FIG. 3. This view continues the progression of guiding cable 10 through post 6 by fully inserting cable post guide 14 against wall 22 with guide walls 26 and 28 adjacent sidewalls 32 and 34, respectively. This causes end 44 of feed guide pin 30 to be positioned adjacent cable hole 16 on wall 20. It is appreciated from this view that by simply inserting feed guide pin 30 into cable hole 18, with the assistance of guide walls 26 and 28, base 24 will position end 44 of feed guide pin 30 in the appropriate position with respect to cable hole 16. It is further appreciated that the size and width of base 24, as well as guide walls 26 and 28, can be adjusted so as to fit any variety of post sizes. Therefore, the cable post guide will fit onto a post like that shown with post 6 in FIG. 3, as well as a post of any variety of sizes. In another embodiment, cable post guide 14 may include a base that has no guide walls, but is sufficiently sized so that, when its cable post guide is inserted into cable hole 18, the end will be located adjacent cable hole 16.

Another detail perspective view of post 6 is shown in FIG. 4. This view is similar to that shown in FIG. 3 with cable post guide 14 fitted onto walls 22, 32, and 34, and with feed guide pin 30 positioned within cavity 36. In this view, end 42 of cable 10 has been inserted into a bore or cable receiver 46 located on end 44 of feed guide pin 30. End 42 has been inserted into cable hole 16 to be positioned as shown. At this point, with engagement made between feed guide pin 30 and cable 10, same can be extended through cavity 36 of post 6. It is appreciated that end 42 of cable 10 does not necessarily need to be extended as far into cable receiver 46 as shown in this illustrative view. It may be possible for end 42 to be located adjacent cable receiver 46 and allow cable post guide 14 to still serve as a guide. Additionally, when moving cable 10 in direction 40 through post 6 using feed guide pin 30, contact between end 42 of cable 10 and end 44 of feed guide pin 30 may not necessarily need to be constant. Feed guide pin 30 provides a reference point for cable 10 so the installer will know where cable hole 18 is in order to extend cable 10 all the way through post 6.

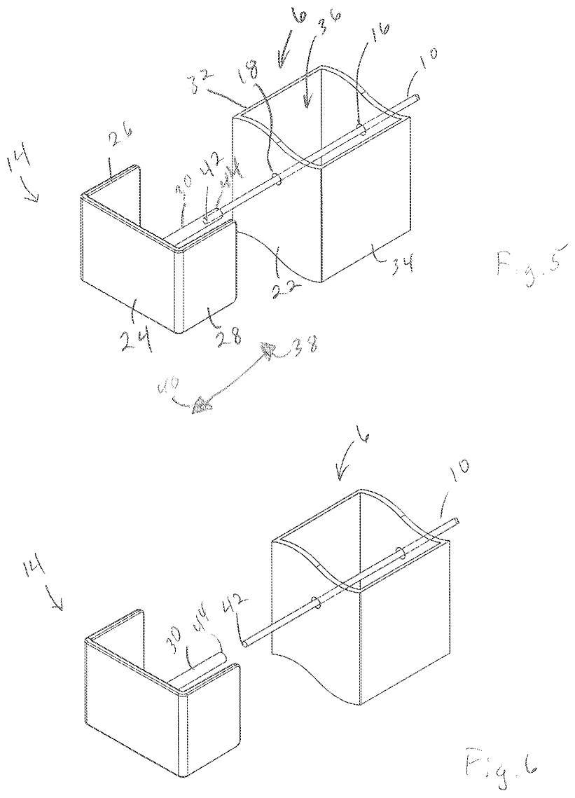

Another detail perspective view of post 6 is shown in FIG. 5. This view continues the progression of feeding cable 10 through post 6. In this view, both cable 10 and cable post guide 14 have been manually moved in direction 40 with end 42 of cable 10 sufficiently contacted to or adjacent end 44 and/or feed guide pin 30 to direct cable 10 through cable hole 16 and out cable hole 18. At this point, cable 10 has been fully extended through post 6 to accomplish this. All the installer had to do was move both cable 10 and cable post guide 14 in direction 40, either concurrently or about concurrently, so that feed guide pin 30 can be fed from cable hole 16 and through cable hole 18.

Another detail perspective view of post 6 is shown in FIG. 6. This is the final step of the progression that feeds cable 10 through post 6. In this view, cable post guide 14 is separated from cable 10, and, particularly, end 44 of feed guide pin 30 is separated from end 42 of cable 10. Now, any length of cable 10 can be pulled through post 6. It is appreciated that this process shown in FIGS. 2-6 can be repeated for other cable holes in this or other posts. Either way, cable post guide 14 provides a convenient method of feeding a cable through a post.

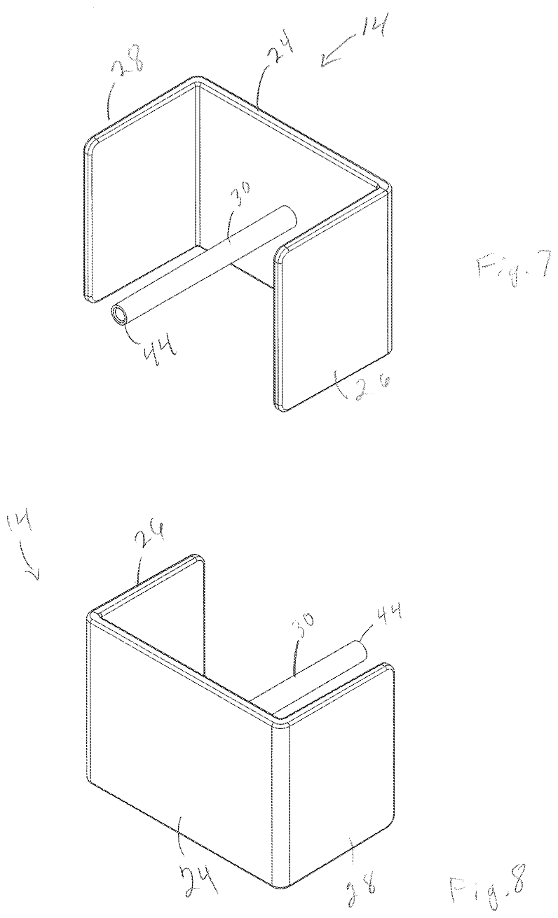

A perspective view of cable post guide 14 is shown in FIG. 7. This view shows feed guide pin 30 extending from base 24 between guide walls 26 and 28. It is appreciated that the configuration of base 24, as well as guide walls 26 and 28, and feed guide pin 30 can be modified to accommodate posts of differing sizes and configurations. For example, base 24 may be made wider or narrower depending on the size of the post it is to be used on. Base 24 may also include cutouts or openings to accommodate obstacles that may be on the surface of the post while still able to extend feed guide pin 30 into the post so end 44 will be positioned adjacent the opposing cable hole. Likewise, with guide walls 26 and 28, they can be differently sized as well to accommodate posts of different size and configuration. Additionally, in other embodiments, only one or no guide walls may be employed. Again, this depends on the configuration of the post and whether cable post guide 14 has the ability to effectively position end 44 adjacent an opposing cable opening or hole in the post. Feed guide pin 30 may be made longer, shorter, and/or with differing diameters and end configurations.

Another perspective view of cable post guide 14 is shown in FIG. 8. This perspective view of cable post guide 14 is similar to that shown in FIGS. 2-6. This view further assists in demonstrating how cable post guide 14 may be constructed of a base 24 with guide walls 26 and 28 and feed guide pin 30 extending from base 24. It is appreciated that feed guide pin 30 may be molded as part of base 24 or attached thereto using a fastener or other connecting mechanism.

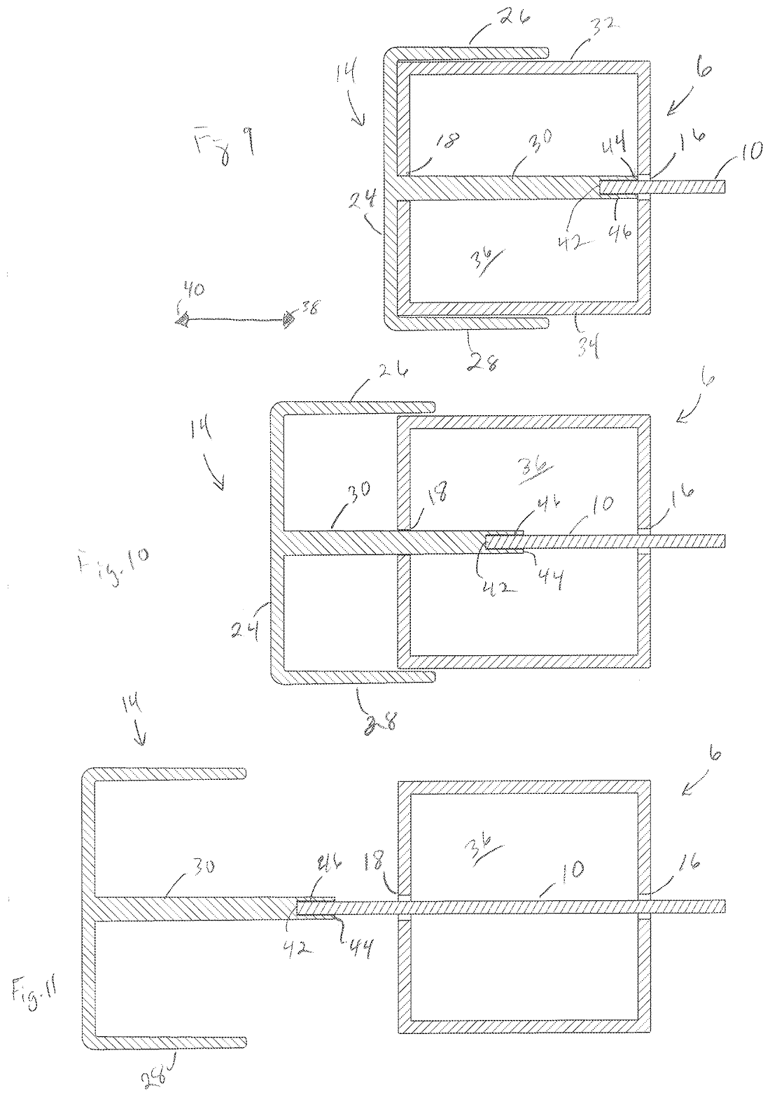

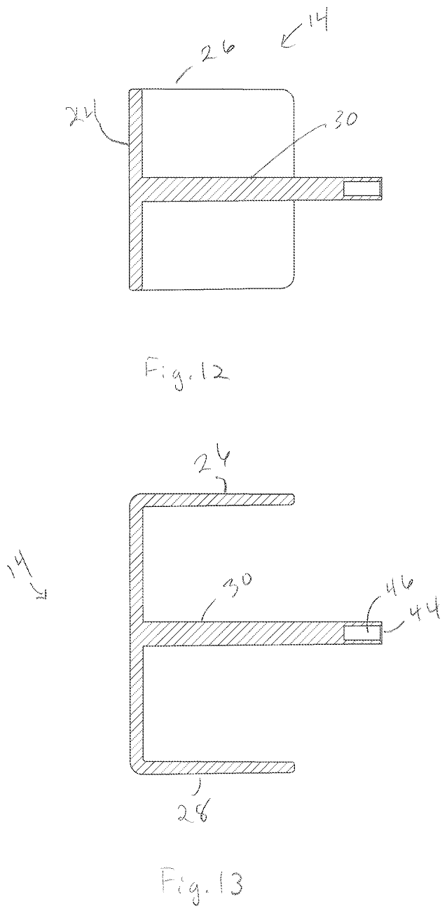

Top cross-sectional views of post 6 and cable post guide 14 are shown in FIGS. 9, 10, and 11. The view in FIG. 9, similar to that of FIG. 3, shows end 44 of feed guide pin 30 located adjacent cable hole 16 of post 6. End 42 of cable 10 is located within cable receiver 46, also adjacent cable hole 16. It is appreciated from this view how cable 10 merely needs to be inserted into post 6 through cable hole 16 in order to engage feed guide pin 30. It is further appreciated that even though end 42 of cable 10 is shown fully inserted into cable receiver 46, in order to feed cable 10 through post 6, this may not be fully necessary to move a cable through a post. For example, end 42 may simply be positioned adjacent and/or abut end 44 of feed guide pin 30. Both cable 10 and cable post guide 14 can be moved in direction 40, concurrently, so that end 42 of cable 10 will extend to cable hole 18 on the opposing side of post 6 from cable hole 16 (see, also, FIG. 11).

Also shown in this view are guide walls 26 and 28 of cable post guide 14 located adjacent sidewalls 32 and 34, respectively, of post 6. From this view, it is appreciated how guide walls 26 and 28, along with base 24, positions cable post guide 14 such that feed guide pin 30 will be properly positioned through cable hole 18, through cavity 36 of post 6, and adjacent cable hole 16. The structures on cable post guide 14 allow same to make this positioning repeatable.

A top cross-sectional view of post 6 and cable post guide 14 is shown in FIG. 10. Here, cable post guide 14 is further moved in direction 40, with cable 10 moving in direction 40, as well as through cable hole 16 and toward cable hole 18. Whether end 42 of cable 10 is fully inserted into cable receiver 46 or just abutting end 44 of feed guide pin 30, cable post guide 14 is able to guide cable 10 through cavity 36 of post 6. Guide walls 26 and 28 assist in ensuring feed guide pin 30 is moving straight out of cable hole 18.

A top view of post 6 and cable post guide 14 is also shown in FIG. 11. This view, as a final step in the progression views of FIGS. 9, 10, and 11, show feed guide pin 30 exterior of cavity 36 of post 6 with cable 10 fully extended through cable hole 16 and cable hole 18. Accordingly, with end 42 of cable 10 either inserted into cable receiver 46 or abutting end 44 of feed guide pin 30, cable post guide 14 can guide cable 10 through post 6 by simply moving both cable 10 and cable post guide 14 in direction 40. It is appreciated that cable post guide 14 can be positioned on either side of post 6 in order to feed cable 10 in either direction from cable hole 18 to cable hole 16 or cable hole 16 towards cable hole 18.

A side cross-sectional view of cable post guide 14 is shown in FIG. 12. Here, feed guide pin 30 is illustratively shown about midway up onto base 24. It is appreciated, however, that based on the location of the holes in a post, the feed guide pin can be located anywhere on base 24 appropriate to serve as a guide for a cable extending through the post.

Also shown are guide walls 26 and 28 in the top view of cable post guide 14, in FIG. 13, similar to that shown by the cable post guide 14 in FIG. 11. Here, feed guide pin 30 is located between guide walls 26 and 28. Cable receiver 46 is shown disposed through end 44 of feed guide pin 30.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, the disclosure from this non-provisional patent application controls.

What is claimed:

1. A cable post guide configured to assist feeding a cable through at least one cable hole disposed through a post, the cable post guide comprising:
a base;
a feed guide pin;
wherein the feed guide pin extends from the base;
a first guide wall that extends from the base;
a second guide wall that extends from the base;
wherein the second guide wall is spaced apart from the first guide wall;
wherein the feed guide pin extends from the base between the first guide wall and the second guide wall;
wherein the feed guide pin is configured to extend through the at least one cable hole disposed through the post;
wherein the feed guide pin includes a cable receiver located at an end of the feed guide pin distal from the base; and
wherein the cable receiver is configured to receive an end portion of the cable.

2. The cable post guide of claim 1, wherein the base has a width configured to be wider than a width of the post.

3. The cable post guide of claim 1, wherein a space is located between the first guide wall and the second guide wall configured to receive the post.

4. The cable post guide of claim 1, wherein the feed guide pin has a length that is configured to extend from a first end of the post and through to a second end of the post.

5. The cable post guide of claim 1, wherein the cable receiver has a bore configured to receive the end portion of the cable.

6. The cable post guide of claim 1, wherein the feed guide pin is configured to be pushed into the at least one cable hole in the post so that the end portion of the cable is extendable into the cable receiver so that when the feed guide pin is removed from the at least one cable hole in the post, the cable is movable with the feed guide pin and extendable through the at least one cable hole.

7. The cable post guide of claim 1, wherein a space is located between the first guide wall and the second guide wall configured to be sized so that when the first guide wall is positioned adjacent a first side surface of the post and the second guide wall is positioned adjacent a second side surface of the post, the cable post guide is aligned with the at least one cable hole of the post.

8. The cable post guide of claim 1, wherein the feed guide pin is configured to be extendable through a first end of the post but not through a second end of the post.

9. The cable post guide of claim 1, wherein a cross-sectional shape of the first guide wall, the base, and the second guide wall are configured to at least approximate at least a portion of a cross-sectional shape of the post and be positionable adjacent the portion of the cross-sectional shape of the post.

10. A cable post guide configured to assist feeding a cable through at least one cable hole disposed through a post, the cable post guide comprising:
a base; and
a feed guide pin;
wherein the feed guide pin extends from the base; and
wherein the feed guide pin is configured to extend through the at least one cable hole disposed through the post.

11. The cable post guide of claim 10, further comprising a first guide wall that extends from the base.

12. The cable post guide of claim 11, further comprising a second guide wall that extends from the base, wherein the second guide wall is spaced apart from the first guide wall.

13. The cable post guide of claim 12, wherein the feed guide pin extends from the base between the first guide wall and the second guide wall.

14. The cable post guide of claim 10, wherein the feed guide pin includes a cable receiver located at an end of the feed guide pin distal from the base.

15. The cable post guide of claim 14, wherein the cable receiver is configured to receive an end portion of the cable.

16. The cable post guide of claim 10, wherein the feed guide pin is configured to be pushed into the at least one cable hole in the post so that an end portion of the cable is extendable into a cable receiver so that when the feed guide pin is removed from the at least one cable hole in the post, the cable is movable with the feed guide pin and extendable through the at least one cable hole.

17. A method of feeding a cable through a post having a first cable opening located on first end of the post and a second cable opening located on a second end of the post, the method comprising the steps of:
providing a cable post guide that includes a base and a feed guide pin extending from the base, wherein the feed guide pin includes a cable receiver;
extending the feed guide pin through the first cable opening of the first end of the post;
engaging an end portion of the cable with the cable receiver adjacent the second end of the post;
pulling the base of the cable post guide away from the first end of the post so that the cable is moving into the post while the feed guide pin is being removed from the post;
continuing moving the base from the post so that the cable post guide exits the first cable opening of the first end of the post with the end portion of the cable also exiting the first cable opening of the first end of the post with the cable extending completely through the post; and
removing the cable receiver from the end portion of the cable.

18. The method of claim 17, further comprising the steps of extending the feed guide pin through the first cable opening of the first end of the post until the base of the cable post guide abuts the first end of the post, and pushing the end portion of the cable against the cable receiver while pulling the base of the cable post guide away from the first end of the post so that the cable is moving into the post while the feed guide pin is being removed from the post.

19. The method of claim 18, further comprising the steps of providing the cable post guide with a first guide wall that extends from the base, a second guide wall that extends from the base, and the second guide wall being spaced apart from the first guide wall, moving the first guide wall and the second guide wall along corresponding side walls on the post when extending the feed guide pin through the first cable opening of the first end of the post until the base of the cable post guide abuts the first end of the post.

20. The method of claim 17, further comprising the steps of moving the feed guide pin through the first cable opening of the first end of the post so the cable receiver becomes located adjacent the second cable opening of the second end of the post when the base abuts the first end of the post, wherein the cable receiver of the feed guide pin does not extend through the second cable opening of the second end of the post.
